(19) United States
(12) Patent Application Publication
(10) Pub. No.: US 2014/0143052 A1
(43) Pub. Date: May 22, 2014

(54) SYSTEM AND METHOD FOR APPLYING ON-LINE BEHAVIOR TO AN OFF-LINE MARKETING CAMPAIGN

(71) Applicant: Charles W. STRYKER, St. Augustine, FL (US)

(72) Inventor: Charles W. STRYKER, St. Augustine, FL (US)

(21) Appl. No.: 14/084,698

(22) Filed: Nov. 20, 2013

Related U.S. Application Data
(60) Provisional application No. 61/728,652, filed on Nov. 20, 2012.

(51) Int. Cl. G06Q 30/02

(52) U.S. Cl. CPC G06Q 30/0261; G06Q 30/0255
USPC 705/14.53; 705/14.58

(57) ABSTRACT

A marketing determination system includes a demand side platform that places a packet of data on computers based on on-line behavior. Consumers access a website and show interest on a product or a service by clicks or viewing time. This behavior is tracked for a geographic location, such as a ZIP+3 code. The number of devices showing interest via this behavior is determined. If enough interest is observed, then an off-line marketing campaign is directed to the geographic location, thereby identifying potential customers due to the level of interest observed on-line.

### FIELD OF THE INVENTION

The present invention relates to the observation, collection, analysis, and application of on-line behavioral data to inform and direct the off-line efforts of organizations (e.g., businesses, schools, charities, governments) as they develop means and messages (e.g., marketing campaigns) to identify, reach, and communicate to parties with potential interest in their offerings (goods, services, ideas). More specifically, the present invention relates to the observation of on-line behavior within a geographic area to identify markets to which off-line marketing efforts should be targeted.

### DESCRIPTION OF THE RELATED ART

Traditional marketing employs a variety of methods to promote a product or service to the public. These include advertising in magazines or newspapers, radio advertisements, direct mail, flyers, outdoor display (e.g., billboards), and the like. Before initiating a marketing campaign, companies engage advertising firms or other experts to perform studies that attempt to identify the best locations in which to market. Historically, these studies have examined demographic data (e.g., income, presence of children, geographic location, education, gender, and many other factors) to predict geographic areas that should return the most business for advertising dollars. For example, counties deemed high-potential for luxury goods may be based upon the average income for households reported for the prior 10 years.

The problem with the above processes is that they can cause advertising to be delivered to consumers who have no interest in the product or service. Using the above example, just because a neighborhood has an affluent population may not mean that families in that neighborhood are interested in luxury cars at the time the campaign is underway. Direct mail efforts are particularly sensitive to this dilemma, as the costs of designing, producing, and mailing letters and packages will increase over time. Non-profit organizations and non-commercial entities may be especially sensitive to these constraints. Advertising budgets cannot afford to spend on mailings targeted to an uninterested audience.

### SUMMARY OF THE INVENTION

The disclosed embodiments offer a remedy to this dilemma. If an individual consumer is observed to engage a particular website or show interest on-line in a product or service, then that individual can be assumed to be sufficiently interested in the product/service—he/she can be considered to be “in-market” for it.

In the on-line world, Demand Side Platforms (DSPs) facilitate the serving of relevant advertisements to individuals who browse the Internet. To do so, DSPs observe who is on-line (by their IP address) and what they are looking at. For instance, a person who visits a site about cruises and later visits a site for a local weather forecast will probably be served an advertisement for a cruise while he/she is looking at the forecast. When specific geographic location is added to the on-line shopping behavior, the result can inform and enhance marketers' off-line campaign efforts.

The disclosed embodiments of the present invention enable systems and methods to identify and market products or services to customers or prospects. The disclosed embodiments use the on-line browsing or shopping behavior of a consumer to identify the best geographic locations for off-line marketing. Use of on-line behavior differs from traditional demographic modeling or studies used to identify such prospects. The demographic modeling approach points indirectly to individuals who might be interested in the product/service. Observed on-line behavior identifies individuals who are actively looking for the product/service.

The disclosed embodiments assess individuals' browsing/shopping behavior across the U.S. and then combine each individual's interest with the geographic neighborhood in which he/she is located, such as at a sub-ZIP code level. Then, the prevalence of observed in-market behavior is calculated for each area, thus identifying neighborhoods that represent a good market (i.e., a high degree of in-market behavior associated with the product/service). The marketer can then communicate to households only in the most desirable neighborhoods via an off-line marketing campaign.

The disclosed embodiments collect the observed behavior at the individual level and then, so as not to raise privacy concerns, aggregate it at the neighborhood level. The off-line marketing outreach campaign is then directed to all households in the neighborhoods that are deemed to be most desirable (including whatever proportion of individual households not observed to be “in-market” for the product/service). In this manner, the marketer does not infringe upon an individual consumer's privacy.

The disclosed processes assess the shopping behavior within millions of small geographic units, such as neighborhoods, and measure the degree of prevalence of the shopping behavior in each neighborhood. The disclosed embodiments may determine those neighborhoods that exhibit the most prevalent shopping behavior for a product or service. This feature provides marketers with a much better targeting capability to reach interested buyers.

According to the present invention, a system for applying on-line behavior to an off-line marketing campaign is disclosed. The system includes a plurality of devices for loading a website to display at the request of consumers. The website provides information on a product or a service. The system also includes a demand side platform to receive a call from the website based upon tracked consumer activity on the website. The demand side platform places a packet of data on the plurality of devices. The system also includes a database to associate an internet protocol (IP) address of the plurality of devices identified by the packets of data with a geographic location of the consumers. The system also includes a computing device to determine whether the plurality of devices within the geographic location relates a value. Addresses for households within the geographic location are identified based on the determination.

Further according to the present invention, a method for applying on-line behavior to an off-line marketing campaign is disclosed. The method includes tracking interest in a product or a service using on-line access to a website from a plurality of devices. The method also includes placing packets of data on the plurality of devices based on the interest. The method also includes associating a geographic location of the plurality of devices using the packets of data. The method also includes determining a value for the interest in the product or the service based upon the geographic location. The method also includes determining information available for households within the geographic location to receive materials regarding the product or the service.

Further according to the present invention, a method for targeting a marketing campaign to a geographic location. The method includes tracking on-line behavior for a product or a service from a plurality of computers. The method also includes calling a demand side platform to place identification data on the plurality of computers in a geographic location based on the behavior. The method also includes determining a level of interest in the product or the service based on a number of computers having the identification data. The method also includes directing an off-line marketing campaign at a plurality of households in the geographic location based on the level of interest.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1A illustrates a system for applying on-line shopping behavior to off-line marketing according to the disclosed embodiments.

FIG. 1B depicts a computing environment for use with the system of FIG. 1A according to the disclosed embodiments.

FIG. 2 illustrates a flowchart for applying observed on-line shopping behavior to enhance off-line marketing according to the disclosed embodiments.

FIG. 3 illustrates a flowchart for applying on-line shopping behavior to identify a geographic location for off-line marketing according to the disclosed embodiments.

FIG. 4 illustrates a process flow diagram according to the disclosed embodiments.

FIG. 5 illustrates a block diagram of identifying in-market households according to the disclosed embodiments.

FIG. 6 illustrates a flowchart for enabling the process software for the determination of on-line behavior to focus an off-line marketing campaign according to the disclosed embodiments.

### DETAILED DESCRIPTION OF THE DISCLOSED EMBODIMENTS

Aspects of the present invention are disclosed in the accompanying description. Alternate embodiments of the present invention and their equivalents are devised without parting from the spirit or scope of the present invention. It should be noted that like elements disclosed below are indicated by like reference numbers in the drawings.

Demand side platforms (DSPs), also known as ad exchanges, offer on-line marketers the ability to identify individuals exhibiting behavior that they are in-market for a particular product. “In-market” may refer to consumers interested in the product. The term is not limited to those people definitely making a purchase or even making a commercial transaction. These products and services may include cruises, automobiles, mortgages, airline travel, hotels, car rentals, and the like. Non-commercial products and services may include local events, museums, shows, exhibits, schools and education, political campaigns, and the like. Essentially, the “consumer” is actively taking action to show interest in some subject on-line. When associated with a precise geography, this observed behavior allows marketers to target desirable neighborhoods of prospects in an off-line mode through direct mail, radio, and television communications. This process is in contrast to the traditional method of identifying consumers off-line by developing an expensive demographic analysis or study.

From a technical prospective, the DSP accomplishes its identification at an individual internet protocol (IP) address level. Effectively, then, the DSP identifies a particular household showing the desired on-line behavior by observing its browsing history. A household may refer to an address in which one or more persons reside. Preferably, a household refers to a family residing at a home address, but the term is not limited thereto. The people in the household preferably have some sort of relationship, even if it is as co-tenants. To address any possible privacy issues, however, marketers do not want to target households at the individual household level. So, the disclosed embodiments revert to a geographically-defined set of several households for a given location.

The geographic unit should be appropriately sized. If the geographic unit is too large (too many households), it does not afford the marketer a satisfactory degree of resolution—too many households that are not in market will receive mail in order for the marketer to reach households that are in market. The cost is not worth the effort. If the neighborhood is too small (too few households), privacy concerns surface, as well as not targeting interested, but uninformed, customers.

A 5-digit ZIP code may appear to be a convenient geographic designation for a geographic area in which to market. At that level, however, ZIP codes are too large for effectively marketing to a targeted audience. For example, 5-digit ZIP codes may average more than 2,000 households each. On the other end of the spectrum, ZIP+4 codes may be too small to effectively reach a target audience. For example, ZIP+4 codes may average only about 3-4 households each. Neighborhoods defined by ZIP+3 codes (which average about 30 households) are more effective in marketing to a targeted audience. They offer a suitable degree of aggregation and anonymization, while still retaining a high degree of internal demographic homogeneity. Hence, they provide the marketer with adequate resolution without wasting resources.

As mentioned, due to privacy issues, targeting communications to an individual household is not prudent. Instead, the disclosed embodiments prefer to communicate to all households within a ZIP+3 code neighborhood of interest. Marketers are willing to communicate to households in a given ZIP+3 code that are not in market in order to reap the benefits of communicating to those households who are in-market.

The disclosed embodiments also identify geographies of interest. A geography of interest may be a location having sufficient interest to warrant off-line marketing efforts. To do so, each ZIP+3 code is measured as to its degree of in-market activity. The disclosed embodiments may implement a plurality of ways to measure a degree of in-market activity within a ZIP+3 code. For example, one measurement may include a count of households in that ZIP+3 code that are in market. Another measurement may include a percentage of households in that ZIP+3 code that are in market. For example, if over 40% of the households in a ZIP+3 code have expressed interest in a product or service based on their on-line behavior, then a marketing company may identify that ZIP+3 code as a geography of interest. Also, marketers may elect to use different thresholds for different areas of the country and/or to change the threshold for different products.

Preferably, the percentage method is implemented because it provides a marketing company with the number of households that are of interest (because they are exhibiting in-market behavior) and the total number of households in each ZIP+3 code. In determining the percentage, the number of households exhibiting in-market behavior may be the numerator and the total number of households in each area may be the denominator. The denominator is essential because marketers must be able to calculate the overall expense for a marketing campaign as the cost of sending mail to each household increases. Such a determination of expense is possible only if the total number of households to which a communication is sent is known.

Thus, in summary, the disclosed process may include:
DSP observes in-market observations at the IP address (household) level for product or service X,
Identifying the location of the IP address at the ZIP+3 level,
Determining the household count for each ZIP+3 in the U.S.,
Calculating the degree of saturation of interest for product or service X for all ZIP+3s,
Deciding the threshold of saturation above which a given ZIP+3 will be selected for inclusion in an off-line marketing campaign,
Calculating the expense of the campaign (cost per campaign x number of total households in selected ZIP+3s), and
Resetting the selection threshold so that campaign budget is not exceeded.

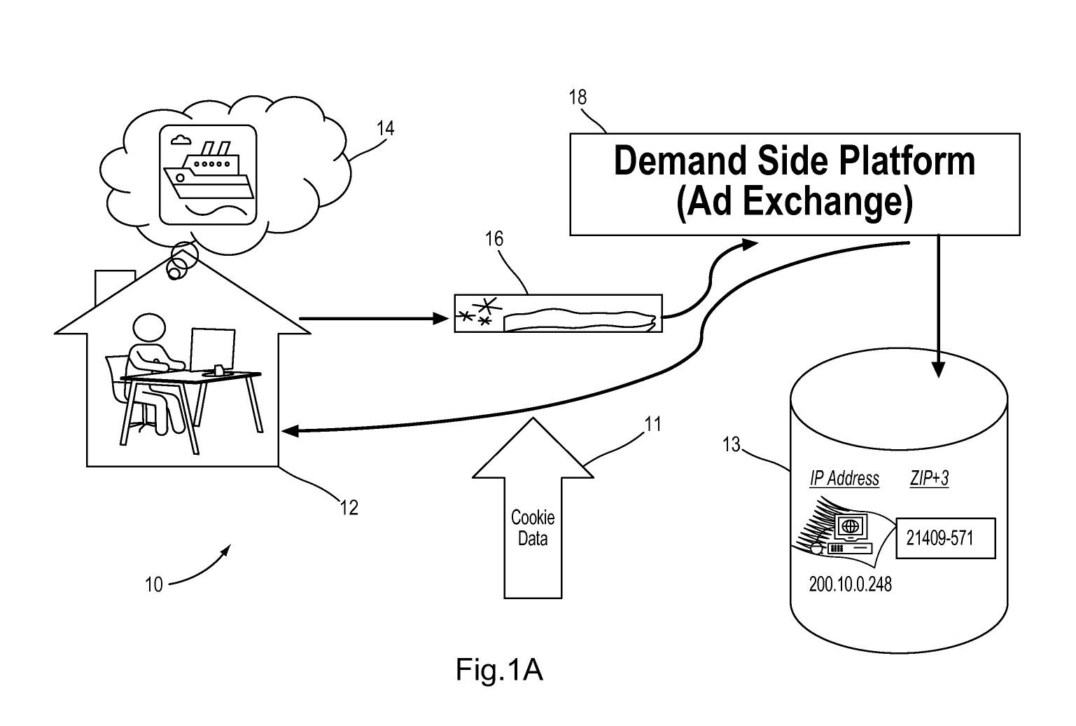

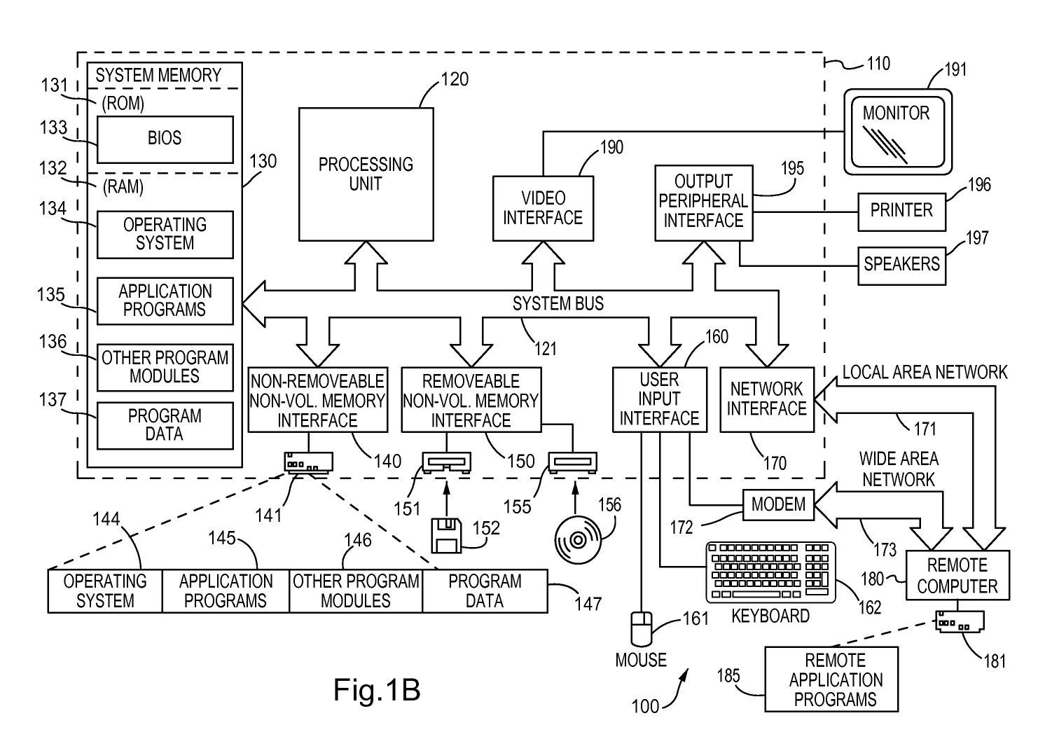

The figures disclosed below illustrate the processes for achieving these objectives and provide additional detail. Referring to FIG. 1A, a system 10 for determining potential consumers based on on-line behavior is depicted according to the disclosed embodiments. The examples and illustrations disclosed below focus on shopping behavior for a consumer interested in purchasing a product or service. The present invention is not so limited and may include non-commercial applications. Any on-line behavior may be used in that this behavior may be tracked and aggregated in order to make an off-line marketing decision. For example, on-line interest in a political campaign may be tracked so that mailings are sent to targeted neighborhoods. This feature may be especially important given budget constraints typical for such operations.

Within system 10, consumer 12 desires to purchase or research a product or service 14 (hereinafter “product”). In this example, product 14 may be a cruise package. There may be many different types of cruise packages for consumer 12 from which to select. The cruise packages include luxury cruises, family cruises, theme cruises, celebrity cruises, friend cruises, and the like. Consumer 12 visits website 16 to review its materials on product 14. Consumer 12 may indicate via click patterns that he or she is shopping for a cruise. As a result, website 16 makes a “call” to DSP 18 based on this level of interest.

DSP 18 may be known as an ad exchange and is connected to a network. Due to the call, DSP 18 places cookie data 11 in real time on consumer 12's computer. The cookie is a piece of data that designates consumer 12's interest in the product and is thus associated with the IP address of the device the consumer used to access the Internet (e.g. computer, tablet, smart device or mobile phone).

Consumer 12 is tagged to a specific geography using a table 13 that contains the ZIP+3 of each IP address in the U.S. (as well as the total number of households in each ZIP+3). Table 13 may include other geographic information apart from ZIP+3 codes. Other geographic designations may be used.

As a result of these actions, system 10 will utilize the following information pertaining to the product:
a) IP addresses that are in-market for the product (in other words, showing active interest in the event the product or service is not commercial),
b) Count of the number of IP addresses in each ZIP+3 that are in-market for the product, and
c) Count of total number of households (IP addresses) in each ZIP+3.

The quotient of (b)/(c) above is the degree of saturation of interest for the product for each ZIP+3. The marketer can then use system 10 to sort the ZIP+3s so that those with the highest saturation are at the top of the list for selection for a marketing campaign. The marketer can also calculate to total number of households in all of the ZIP+3s to be reached by the campaign by summing the counts for (c).

The elements of FIG. 1A are shown for illustrative purposes only. Consumer 12 identifies an individual computer or other processing device used by a consumer to access website 16 via the Internet. Through a network within system 10, DSP 18 may exchange data with website 16 and the computer of consumer 12. DSP 18 and table 13 do not have to be located in the same physical location. Further, consumer 12 is not limited to executing a commercial transaction, but may include one just interested in product 14.

Product 14 may refer to any product or service of interest to consumer 12. For example, if consumer 12 is interested in an automobile, then product 14 may be separated by manufacturer or vehicle type. Retail shopping also may be the subject of product 14, such as clothing and accessories, consumer electronics, DVDs, movies and music, health home and garden, toys, games and video games, and the like. For vacations and travel, airlines and other transportation means may be included along with hotels and lodging, car rentals, cruises and the like. Consumer 12 also may be shopping for financial services, such as credit cards, financial planning, insurance, mortgages, loans, and the like. Other industries represented by product 14 may include floral and garden, food and beverage, health and beauty, household suppliers, pet supplies, and the like. Non-profit and non-commercial events, products and services, or ideas also may be shown by product 14.

In other words, a separate entity may have a database containing geographic information used in the disclosed embodiments, such as IP addresses and corresponding ZIP+3 codes. This database is separate from DSP 18. DSP 18 includes data having the IP addresses and a product of interest identified by browsing on the Internet. Another database includes ZIP+3s and a count of the households within each ZIP+3. Although not shown, these databases are accessible within system 10.

The disclosed embodiments combine these databases to create a database within system 10 that includes the IP address, the identified product of interest, ZIP+3, and a count of households in each ZIP+3. This database may reside anywhere, even at a third-party site. The information stored in this database is then used in the disclosed processes to facilitate marketing efforts.

FIG. 1B depicts a computing environment for implementing the processes disclosed below and to be used in conjunction with system 10 of FIG. 1A. FIG. 1B is intended to show a general description of a suitable computing environment. It should be noted that handheld, portable, tablet, smart device, smart watches, and other computing devices are contemplated for use in connection with the disclosed embodiments. While a general purpose computer is disclosed below, this is but one example.

The disclosed embodiments also may be operable on a thin client having network server interoperability and interaction. The disclosed embodiments also may be implemented in an environment of networked hosted servers in which very little or minimal client resources are utilized, such as a networked environment in which the client device serves merely as a browser or interface to the Internet or other network, or an application executing on a device to allow such access. In a distributed computing environment, the program modules embodying the functions disclosed below may be located in both local and remote computer storage media including memory storage devices.

FIG. 1B shows a computing system environment 100 in the form of a computer 110. Components of computer 110 may include, but are not limited to, a processing unit 120, a system memory 130, and a system bus 121 that couples various system components, including the system memory 130 to processing unit 120. System bus 121 may be any of several types of bus structures, including a memory bus or memory controller, a peripheral bus, and a local bus using a variety of bus architectures.

Computer 110 typically includes a variety of computer readable media. Computer readable media may include media that can be accessed by computer 110. The media includes volatile and nonvolatile, removable and non-removable media. Computer readable media may include computer storage media and communication media.

Computer storage media includes any media implemented in any method or technology for storage of information such as computer readable instructions, data structures, program modules, and the like. It also includes random access memory (RAM), read-only memory (ROM), electrically-erasable programmable read-only memory (EE-PROM), flash memory or other memory technology, compact disc read-only memory (CDROM), digital versatile discs (DVD) or other optical storage disc storage, magnetic cassettes, magnetic tape, magnetic disk storage, and the like. Computer storage media is accessible by computer 110.

Communication media includes computer readable instructions, data structures, program modules and the like in a modulated data signal such as a carrier wave or other transport mechanism and includes any information delivery media. The term “modulated data signal” refers to a signal that has or more of its characteristics set or changed in such a manner as to encode information into the signal. Thus, communication media may refer to wired media such a wired network or direct wired connection, and wireless media such as acoustic, radio frequency (RF), infrared, and other wireless media. Combinations of any of the above should also be included within the scope of computer readable media.

System memory 130 includes computer storage media, such as ROM 131 and RAM 132. A basic input/output system (BIOS) 133 includes basic routines that help to transfer information between elements within computer 110, such as during start-up, and are stored in ROM 131. RAM 132 includes data or program modules that are immediately accessible to or presently being used by processing unit 120. FIG. 1B depicts an operating system 134, application programs 135, other program modules 136 and program data 137 for a device. RAM 132 may store other data or program modules.

Computer 110 also may include a hard disk drive 141 that reads from or writes to non-removable, non-volatile magnetic media. Computer 110 also includes a magnetic disk drive 151 that reads from or writes to a removable, non-volatile magnetic disk 152. Computer 110 also includes an optical disk drive 155 that reads form or writes to a removable, non-volatile optical disk 156, such as a CDROM. Hard disk drive 141 is connected to system bus 121 through a non-removable memory interface such as interface 140, and magnetic disk drive 151 and optical disk drive 155 are typically connected to system bus 121 by a removable memory interface, such as interface 150.

The drives and their associated computer storage media disclosed above and shown in FIG. 1B provide storage of computer readable instructions, data structures, program modules, and other data for computer 110. Hard disk drive 141 stores operating system 144, application programs 145, other program modules 146, and program data 147. Note that these components can either be the same as or different from operating system 134, application programs 135, other program modules 136 and program data 137, and may reside in different memory locations. The different numeral designations may reflect different copies.

A user may enter commands and information into computer 110 through input devices such as keyboard 162 and pointing device, or “mouse,” 161. Pointing device 161 also may be known as a trackball or touch pad. For a tablet or smart device embodiment, pointing device 161 refer to a screen configured for the input of information via a touchscreen. The input devices are connected to processing unit 120 through user input interface 160 that is coupled to system bus 121, but may be connected by other interface and bus structures, such as a parallel port, game port or universal serial bus (USB) port.

A display 191 also is connected to system bus 121 via an interface, such as video interface 190. In addition to display 191, computer 110 also may include other peripheral output devices, such as speakers 197 and printer 196, which may be connected through an output peripheral interface 195.

Computer 110 may operate in a networked environment using logical connections to one or more remote computers, such a remote computer 180. Remote computer 180 may be a personal computer, a server, a router, a network PC, a peer device or other common network node, and may include the elements disclosed above relative to computer 110, although FIG. 1B shows a memory storage device 181. Remote computer 180 may be accessed over a network to execute remote application programs 185. Programs 185 may embody the some or all of the processes disclosed below with regard to system 10.

The networks may include local area network (LAN) 171 and wide area network (WAN) 173, but also may include other networks. A cloud network environment 174 also may be used to store and access data by computer 110. The network environment used by computer 110 within system 10 exchanges data and information between the various components and devices linked to the network.

When used in a LAN networking environment, computer 110 is connected to LAN 171 through a network interface or adapter 170. When used in a WAN networking environment, computer 110 may include a modem 172 or other means for establishing communications over WAN 173, such as the Internet. Modem 172 may be internal or external to computer 110 and connected to system bus 121 via user input interface 160, or another appropriate mechanism. In a networked environment, program modules depicted relative to computer 110, or portions thereof, may be stored in the remote memory storage device, shown as remote application programs 185.

Computer 110 and other client devices may be deployed as part of a computer network. In this regard, the disclosed embodiments pertains to any computer system having any number of memory or storage units, and any number of applications and processes occurring across any number of storage units or volumes. The disclosed embodiments also may apply to an environment with server computers and client computers deployed in a network environment, having remote or local storage. The disclosed embodiments also may apply to a stand-alone computing device, having programming language functionality, interpretation, and execution capabilities.

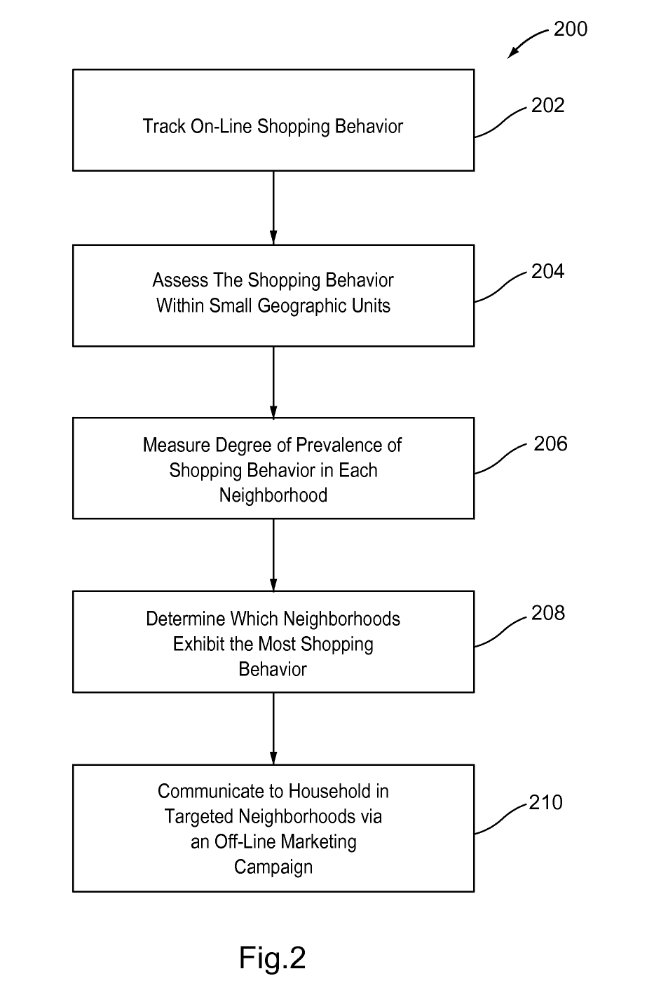

FIG. 2 depicts a flowchart 200 for applying on-line behavior to off-line marketing according to the disclosed embodiments. FIG. 2 may reference elements of FIGS. 1A and 1B. FIGS. 1A and 1B, however, are not limited to the embodiments disclosed below. Further, FIG. 2 also may include additional features not shown in FIG. 1.

Step 202 executes by tracking on-line behavior by consumer 12. The tracking step may include observing on-line behavior as consumer 12 clicks on different websites 16 using a computer or device. The disclosed embodiments may wait to identify observed behavior by limiting the number of clicks. In other words, if the consumer 12 clicks on website 16 three times, then this observed behavior may be noted by system 10.

Step 204 executes by assessing the behavior of consumers 12 within small geographic units. As disclosed above, these small geographic units may be ZIP+3 codes having about 30 households. The observed on-line behavior indicates a particular level of interest. This assessment may occur over a period of time, or under other specified conditions. For example, the disclosed embodiments may observe the on-line behavior and number of clicks/visits to a website over a 3-month period.

Step 206 executes by measuring the degree of prevalence of on-line behavior in each neighborhood. As disclosed above, the percentage of households within a given neighborhood (e.g., defined by a ZIP+3) showing interest in product 14 as divided by the total number of households within the neighborhood may be used to measure interest by that location in product 14, as disclosed above. Neighborhoods exhibiting a slight interest, say 10%, for product 14 are not identified as likely candidates for a marketing campaign. The marketing company may determine that in-market penetration for a ZIP+3 code must be at or above a desired threshold (e.g., 40%). If above the threshold, then this neighborhood, or geographic area, may be selected as a candidate for the marketing campaign.

Step 208 executes by determining which neighborhoods exhibit the most desired on-line behavior. Step 208 may be executed in conjunction with step 206 in that neighborhoods are identified meeting the degree of prevalence for on-line behavior; then, the top neighborhoods are selected from this group. For example, the top five or ten ZIP+3 codes may be selected. Step 208 helps identify those neighborhoods as the best candidates for the marketing campaign.

For a company having a set marketing budget, a determination of the top five or ten neighborhoods may help plan an efficient and cost effective market campaign by not marketing to every neighborhood showing interest. Neighborhoods (e.g., ZIP+3s) will be sorted in descending order on their degree of interest in product 14. Then, neighborhoods will be selected from the top (highest-ranking) down until the preset marketing budget is exhausted. Using the political campaign example, marketing efforts are not wasted in locations unlikely to embrace a candidate.

Step 210 executes by communicating to those households in the targeted neighborhoods selected above using an off-line marketing campaign. The addresses of the households within the ZIP+3 code may be loaded into a file sent to a marketer using the disclosed embodiments. These addresses then may be placed on materials used for an off-line, or mailing, marketing campaign. In fact, this process may be automated so that the addresses are loaded directly onto a computer that directs the production of the direct mail materials. An off-line marketing campaign includes direct mail, catalogues, advertising, and local newspapers or local radio, addressable TV, coupon books, and the like.

In other words, the marketing company's campaign will use Internet-based activities to inform non-Internet marketing outreaches to potential customers. To assuage possible privacy issues, mailings will be sent to every household within each ZIP+3 neighborhood identified above (including those that do not exhibit in-market, on-line behavior).

By doing this, the disclosed embodiments will reach a sufficient number of consumers 12 interested in product 14. They will also reach individuals 12 that may not have exhibited on-line interest in product 14 but, however, may be responsive to the off-line campaign. People live in neighborhoods or locations that tend to reflect their socio-economic status or similar interest in backgrounds. On-line behavior, therefore, may be used to identify neighborhoods as ideal candidates for marketing campaigns focused to those consumers 12 having similar interests already shown by on-line behavior.

Thus, the process disclosed by flowchart 200 may be used in the following applications. The disclosed process may deliver focused materials to in-market potential customers. These are persons whose web behavior indicates that they are interested in a given product, such as mortgages, cruises, automobiles, events, candidates, and the like. The disclosed process also may also shape marketing and other outreach campaigns, as the process identifies significant volumes of in-market buyers. The resulting focus identifies consumers who are in-market within a geographic unit. System 100 may include a searchable table that contains product, ZIP+3 code and the proportion of Internet addresses in each ZIP+3 code that are in-market for product 104 during a given period of time.

This searchable table may identify four segments for marketers. The first segment is “high-potential prospects”. These prospects are ZIP+3 codes that contain a desired level of in-market prospects and that also meet traditional demographic characteristics used for mail modeling, such as income, age, presence of children, and the like. The second segment is “hidden prospects”. Hidden prospects are those ZIP+3 codes that contain the desired level of in-market prospects but that do not meet traditional demographic characteristics used for mail modeling. These are customers that traditional demographically-based models would fail to identify and select.

The third segment is “false positives”. False positives are ZIP+3 codes that do not contain the desired level of in-market prospects but they do meet traditional demographic characteristics used for mail modeling. These are customers that traditional mail models would have selected, yet they are not in-market for product 14. The fourth segment is “solid suppressions”. Solid suppressions are ZIP+3 codes that do not contain the desired level of in-market activity, and they do not meet traditional demographic characteristics used for mail modeling. Thus, solid suppressions may not be identified under existing processes for marketing campaigns that may prove to be successful. Using the disclosed embodiments, solid suppressions will not be identified and targeted for marketing.

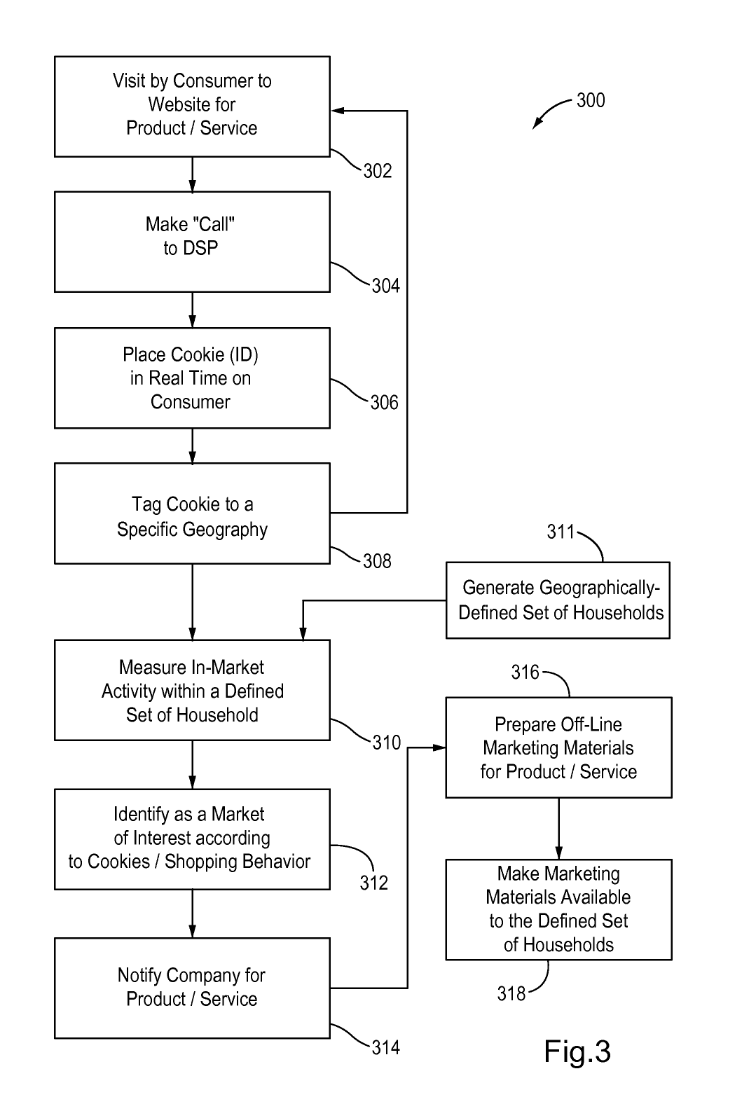

FIG. 3 depicts a flowchart 300 for applying on-line behavior to identify off-line marketing campaigns according to the disclosed embodiments. FIG. 3 is a more detailed description of the process disclosed in FIG. 2.

Step 302 executes by consumer 12 visiting website 16 to research or browse the product 14. Consumer 102 may access a website 16 by typing in its URL into a browser. Alternatively, consumer 12 may click on search results or links leading to website 16. After a specified amount of browsing, such as clicking on additional links or time spent on website 16, step 304 may execute by making a “call” to DSP 18. Website 16 may send a data packet to DSP 108 after sufficient interest is shown by consumer 12 and product 14.

Step 306 executes by DSP 18 placing cookie data 11, or any other type of identification, in real time on the computer of consumer 12. While consumer 12 is connected to website 16, DSP 18 may place cookie data 11 in the memory of a computer, such as computer 110. Step 308 executes by tagging cookie data 11 to a specific geography based upon the IP address of consumer 12. As disclosed above, this specific geography may be a ZIP+3 code associated with an IP address registered via Internet service providers within databases accessible by the disclosed embodiments. For the purposes of the disclosed embodiments, the specific address or location of an IP address is not made available to marketing companies. Instead, the ZIP+3 code or any other small geographic location designation is provided.

Step 310 executes by measuring in-market activity within the defined set of neighborhoods (ZIP+3 geographies). Households (actually computers, identified by an IP address, within a household) have cookie data 11 placed on them and are counted to measure on-line behavior. Step 311 executes by generating information regarding the geographically-defined set of households. Step 311 may be executed in conjunction with step 310. Using the above examples, ZIP+3 codes may be used to define sets of households. Step 310 measures on-line behavior within the defined sets.

Step 312 executes by identifying the defined set of households as a geographic unit of interest according to placed cookies and on-line behavior. The number of cookies placed at IP address within the defined set of households over a certain period or other discriminating criteria may be used to identify that location as a geographic unit of interest.

Step 314 executes by notifying the marketing company that a sufficient level of interest exists for product 14 within the defined set of households (i.e., a neighborhood defined by a ZIP+3). The disclosed embodiments may set a percentage, such as 40%, as the level needed to reach before a neighborhood is selected to participate in a marketing campaign.

Step 316 executes by preparing off-line marketing materials for product 14 based upon the sets of households identified by the on-line behavior. As noted above, the information identified by the disclosed embodiments may be placed in a data file that is stored or sent to a computer. The address information is then placed on the mailing materials sent to those households. This step may be automated such that the addresses are automatically placed on the materials. Step 318 executes by making materials available to the defined set of households. As disclosed above, direct mail and other advertising may be used to reach the households within a geographic location identified by the above steps.

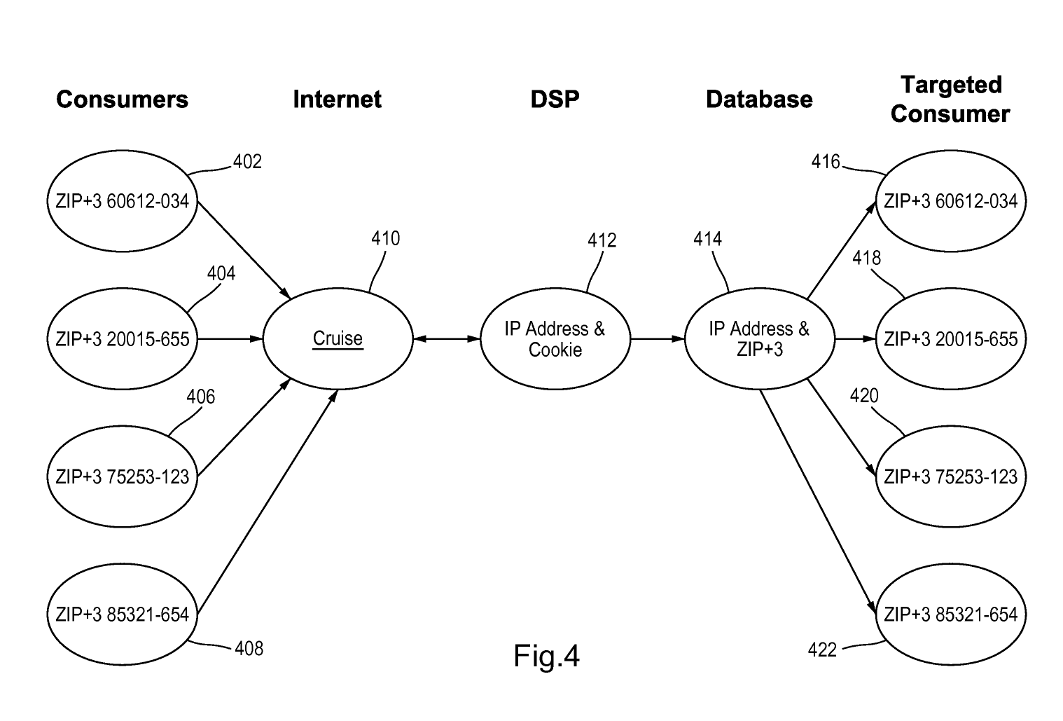

FIG. 4 depicts a process flow diagram according to the disclosed embodiments. FIG. 4 shows ZIP+3 codes 402, 404, 406 and 408 representing a defined set of households within a geographic location. Referring to ZIP+3 code 402, the ZIP+3 code may be 60612 with the +3 being 034. ZIP+3 code 402 is in a different geographic location than ZIP+3 codes 404, 406 and 408. Consumers 12 within codes 402-408 access website 16 and show interest in cruise 410. Cruise 410 may relate to product 14, as disclosed above.

Website 16, hosting information regarding cruise 410, contacts DSP 18 which generates IP address and cookie information 412. Thus, the disclosed embodiments know that a cookie is placed on computers within each of codes 402-408. IP address and ZIP+3 code information 414 may be supplied by database 112 based upon the activity observed within codes 402-408. Based upon this activity, the disclosed embodiments identify target consumer codes 416, 418, 420 and 422. Codes 402-408 have shown sufficient on-line behavior to be identified as targeted consumer locations 416-422.

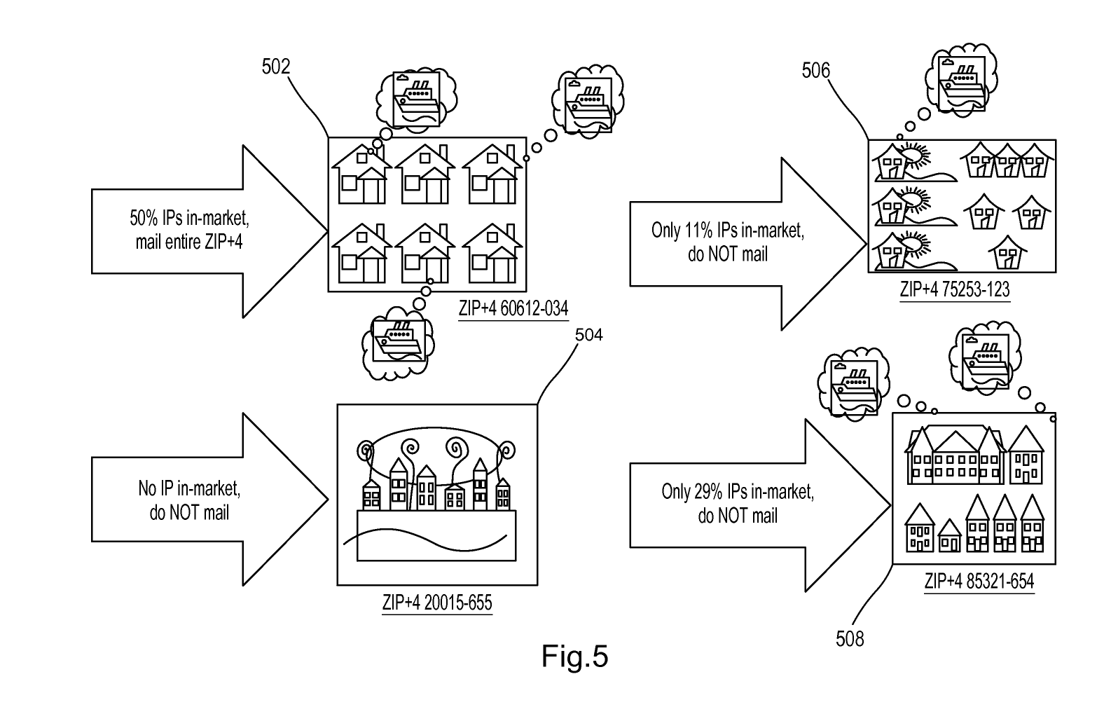

FIG. 5 depicts a block diagram of the identification process according to the disclosed embodiments. FIG. 5 includes defined sets of neighborhoods 502, 504, 506 and 508. Neighborhoods 502-508 correspond to ZIP+3 codes. Within neighborhood 502, on-line behavior shows an interest in product 104, represented as cruises in this example, of 50% for the IP addresses in-market. The disclosed embodiments then mail marketing materials to the entire ZIP+3 code mailing addresses.

Neighborhood 504, for the same period of time, shows no IP addresses having any on-line behavior in-market. Thus, the disclosed embodiments do not mail any materials to the mailing addresses within neighborhood 504.

Neighborhood 506 shows only 11% of the IP addresses having sufficient on-line behavior in-market. As shown, one household out of nine has visited website 106 for product 104 within the specified period of time. The disclosed embodiments do not recommend this ZIP+3 code as eligible for marketing materials.

Neighborhood 508 includes two households showing sufficient on-line behavior for product 104. Thus, the disclosed embodiments do not recommend mailing any materials to the households within neighborhood 508.

As a marketing budget increases, then the percentages may be lowered to include more ZIP+3 codes. If the geographies of interest are ranked, then the marketing dollars may be allocated to mailing to a certain number at the top of the list while adding the next locations in the list as the budget increases. This way, the marketing dollars are spent efficiently and not blindly, or based on faulty demographic assumptions.

As noted above, the disclosed embodiments are not limited to commercial products and services. The on-line behavior is not limited to behavior associated with shopping for hard goods or commercial services. Using the political campaign example, enough interest in a location of a political issue can prompt a marketing effort about that political issue. Another example may be on-line interest in outdoor markets prompts off-line marketing for a local farmers market. Thus, the disclosed embodiments include any product, service, event, idea, personality, issue, and the like that is represented on-line.

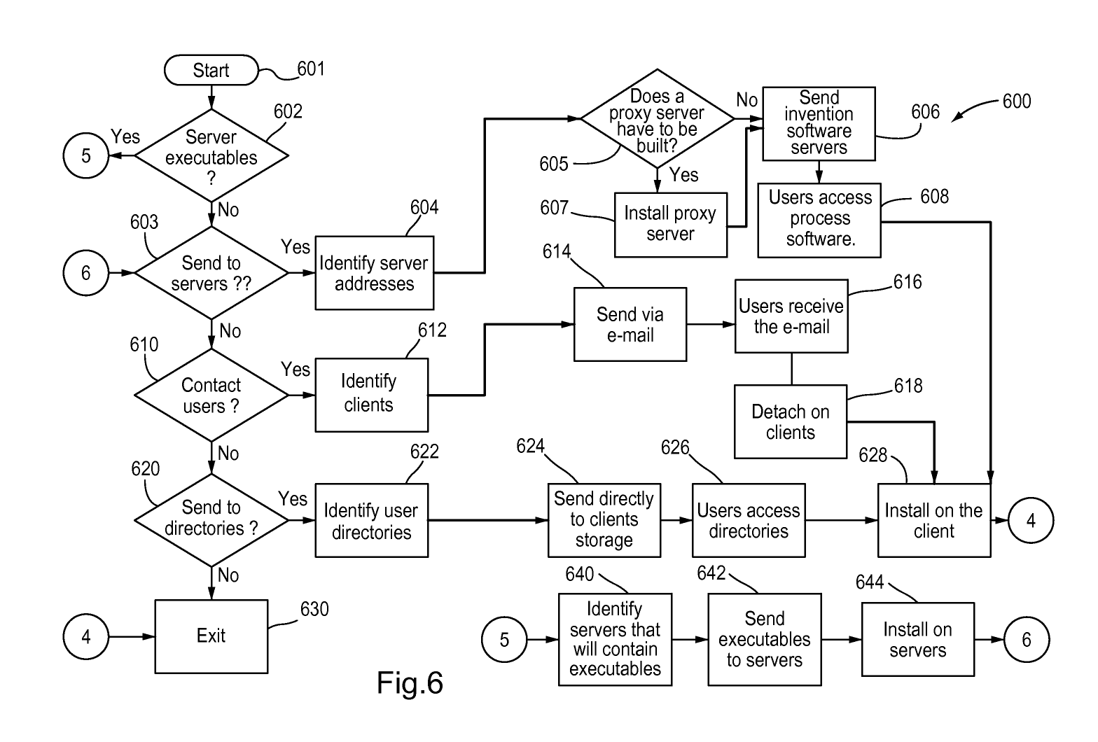

FIG. 6 depicts a flowchart 600 for enabling the determination of on-line behavior to focus an off-line marketing campaign according to the disclosed embodiments. While it is understood that any software implementing may be deployed by manually loading directly into the client, server and proxy computers via loading a storage medium such as a CD, DVD and the like, the disclosed software also may be automatically or semi-automatically deployed into a computer system by sending the software to a central server or a group of central servers. The software is then downloaded into the client computers that will execute the disclosed processes. Alternatively, the software embodiments are sent directly to the client system via an email or message.

The software embodiments may be detached to a directory or loaded into a directory by a button on the email or message that executes a program or wizard that detaches the process software directly into the directory on the client computer hard drive. When there are proxy servers, the disclosed embodiments will, select the proxy server code, determine on which computers to place the proxy servers' code, transmit the proxy server code, then install the proxy server code on the proxy computer. The process software will be transmitted to the proxy server and then it will be stored on the proxy server.

Step 601 executes by starting the deployment of the software embodying the processes and features disclosed above. The first action is to determine if there are any programs that will reside on a server or servers when the disclosed embodiments are executed, as determined in step 602. If yes, then step 640 executes by identifying the servers that will contain the executables. Step 642 executes by sending the executables to the servers. The software processes of disclosed embodiments for the server or servers are transferred directly to the servers' storage via FTP or some other protocol or by copying through the use of a shared file system. Step 644 executes by installing the software on the servers. If step 602 is no, then flowchart 600 proceeds to step 603.

Step 603 executes by determining whether to send the disclosed software and embodiments to the servers. The determination may be made whether the process software is to be deployed by having users access the process software on a server or servers. Step 604 executes by identifying server addresses. If the users are to access the process software on servers, then the server addresses that will store the process software are identified.

Step 605 executes by determining whether a proxy server has to be built. A determination is made if a proxy server is to be built to store the process software. A proxy server is a server that sits between a client application, such as a web browser, and an actual server. The proxy server intercepts all requests to the real server to see if it can fulfill the requests itself. If not, it forwards the request to the real server. The primary benefits of a proxy server are to improve performance and to filter requests. If a proxy server is required, then step 607 executes by installing the proxy server.

Step 606 executes by sending the process software to servers. The process software is sent to the servers either via a protocol such as FTP or it is copied directly from the source files to the server files via file sharing. Alternatively, a transaction is sent to the servers that contain the process software and the server processes the transaction. The process software is received and copied to the server's file system. Step 608 executes by having the users access the process software. Once the process software is stored at the servers, the users via their client computers, then access the process software on the servers and copy to their client computers' file systems. Another embodiment is to have the servers automatically copy the process software to each client and then run the installation program for the process software at each client computer. Step 628 executes by having the user execute the program that installs the process software on his client computer. Step 630 exits flowchart 600.

Step 610 executes by contacting the users. A determination is made whether the process software is to be deployed by sending the process software to the users via email or message, and the like. Step 612 executes by identifying clients. The set of users where the process software will be deployed is identified together with the addresses or designation for the user client computers. Step 614 executes by sending the process software to the client computers of each of the users. Step 616 executes by having the users receive the email. Step 618 executes by detaching the process software from the email, message and the like to a directory on the client computer. Step 628 executes by installing the process software on the client computer.

Step 620 executes by determining whether to send the process software to directories. A determination is made on whether the process software will be sent directly to the user directories on the client computers. Step 622 executes by identifying the user directories. Step 624 executes by sending the process software directly to the storage on the client computer. The process software may be transferred directly to the directory on the client computer. This action may be accomplished in several ways, such as, but not limited to, sharing of the file system directories, and then copying from the sender's file system to the recipient's file system, or, alternatively, using a transfer protocol, such FTP. Step 626 executes by having the users access the directories. The users access the directories on their computers or client file systems in preparation for installing the process software in step 628.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiments were chosen and described in order to best explain the principles of the invention and the practical application, and to enable others of ordinary skill in the art to understand the invention for embodiments with various modifications as are suited to the particular use contemplated.

It will be apparent to those skilled in the art that various modifications and variations can be made in the disclosed embodiments of the present invention without departing from the spirit or scope of the invention. Thus, it is intended that the present invention covers the modifications and variations of the above specification provided that these come within the scope of the claims and their equivalents.

1. A system for applying on-line behavior to an off-line marketing campaign, the system comprising:
a plurality of devices for loading a website to display at the request of consumers, wherein the website provides information on a product or a service;
a demand side platform to receive a call from the website based upon tracked consumer activity on the website, wherein the demand side platform places a packet of data on the plurality of devices;
a database to associate an internet protocol (IP) address of the plurality of devices identified by the packets of data with a geographic location of the consumers; and
a computing device to determine whether the plurality of devices within the geographic location relates a value, wherein addresses for households within the geographic location are identified based on the determination.

2. The system of claim 1, wherein the computing device includes a processor configured to determine a number of the plurality of devices having a packet of data from the demand side platform.

3. The system of claim 1, wherein the plurality of devices includes computers.

4. The system of claim 1, wherein the value corresponds to a percentage of the plurality of devices having the packet of data compared to the total number of devices within the geographic location.

5. The system of claim 1, wherein the value corresponds to a number of the plurality of devices having the packet of data stored thereon.

6. A method for applying on-line behavior to an off-line marketing campaign, the method comprising:
tracking interest in a product or a service using on-line access to a website from a plurality of devices;
placing packets of data on the plurality of devices based on the interest;
associating a geographic location of the plurality of devices using the packets of data;
determining a value for the interest in the product or the service based upon the geographic location; and
determining information available for households within the geographic location to receive materials regarding the product or the service.

7. The method of claim 6, further comprising loading the website onto the plurality of devices to display the product or the service to a consumer.

8. The method of claim 6, further comprising calling a demand side platform to place the packets of data on the plurality of devices.

9. The method of claim 8, wherein the calling step occurs after enough interest in the product or the service is tracked on the website.

10. The method of claim 6, further comprising sending the materials to the households using the information.

11. The method of claim 6, wherein the geographic location includes a ZIP+3 code area.

12. The method of claim 6, wherein the determining step includes determining a percentage of the devices having the packets of data compared to a total number of devices within the geographic location.

13. The method of claim 6, wherein the value corresponds to the number of devices having the packet of data stored thereon.

14. A method for targeting a marketing campaign to a geographic location, the method comprising:
tracking on-line behavior for a product or a service from a plurality of computers;
calling a demand side platform to place identification data on the plurality of computers in a geographic location based on the behavior;
determining a level of interest in the product or the service based on a number of computers having the identification data; and
directing an off-line marketing campaign at a plurality of households in the geographic location based on the level of interest.

15. The method of claim 14, wherein the determining step includes determining a percentage of the number of computers having the identification data to a total number of computers for the geographic location for the level of interest.

16. The method of claim 15, wherein no action is taken if the level of interest is below a value.

17. The method of claim 15, wherein the tracking step includes determining a number of clicks for the product or the service on a website.

18. The method of claim 15, further comprising generating the plurality of households for the geographic location.

19. The method of claim 15, wherein the directing step includes mailing materials to the plurality of households.

20. The method of claim 19, wherein the tracking step includes determining the amount of time spent on a page of a website.
